(19) United States
(12) Patent Application Publication
(10) Pub. No.: US 2020/0073138 A1
(43) Pub. Date: Mar. 5, 2020

(54) TUNABLE FILM APPARATUS

(71) Applicant: GM GLOBAL TECHNOLOGY OPERATIONS LLC, Detroit, MI (US)

(72) Inventor: Kai-Han Chang, Madison Heights, MI (US)

(21) Appl. No.: 16/120,572

(22) Filed: Sep. 4, 2018

(51) Int. Cl. G02B 27/48; G02F 1/137; G02F 1/1334; C09K 19/54; C08G 73/10; C08G 77/04

(52) U.S. Cl. CPC G02B 27/48; G02F 1/137; G02F 1/1334; C09K 19/542; G03B 21/56; C08G 77/04; G02F 2203/01; G02F 2203/02; G02F 2203/09; C08G 73/1096

(57) ABSTRACT

A tunable film apparatus is provided. The apparatus includes: first and second layers; a tunable liquid crystal layer disposed between the first and second layers; and a tuner configured to tune the liquid crystal layer to adjust a light diffusing angle of the tunable liquid crystal layer.

### INTRODUCTION

Apparatuses and methods consistent with exemplary embodiments relate to displaying images. More particularly, apparatuses and methods consistent with exemplary embodiments relate to devices used to improve image quality of displayed images.

### SUMMARY

One or more exemplary embodiments provide an apparatus that reduces speckle. More particularly, one or more exemplary embodiments provide an apparatus that including a tunable light control film configured to reduce speckle in a displayed image.

According to an aspect of an exemplary embodiment, a tunable film apparatus is provided. The apparatus includes first and second layers, a tunable liquid crystal layer disposed between the first and second layers, and a tuner configured to tune the liquid crystal layer to adjust a light diffusing angle of the tunable liquid crystal layer.

The first and second layers may be glass substrates or plastic substrates.

The tunable liquid crystal film may include liquid crystals suspended in an elastomer. The elastomer may form a polymer matrix.

The elastomer may be a side-chain azobenzene elastomer or main-chain azobenzene elastomer. The elastomer may be a silicone dielectric elastomer.

The tuner may output a waveform to the tunable liquid crystal layer.

The frequency of the waveform may be greater than a refresh rate of a display configured to receive light transmitted through the tunable liquid crystal layer.

The tuner may include a waveform generator configured to output the waveform.

The tuner may be configured to output a multi-wavelength light to the tunable liquid crystal layer.

The tuner may include an illumination device configured to output the light.

The tuner may be configured to introduce temporal averaging in the tunable liquid crystal layer.

The tunable film apparatus may be a display configured to receive a laser to display an image.

The tunable film apparatus may be disposed on top of a screen and a laser projector, and may be configured to receive a laser from the laser projector.

The tunable film apparatus may be disposed between a screen and a laser projector, and may be configured to receive a laser from the laser projector and transmit the received laser to the screen.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows illustrations of tunable film apparatuses according to several aspects of an exemplary embodiment;

FIG. 2 shows an illustration of a tunable film apparatus used as a screen according to an aspect of an exemplary embodiment;

FIG. 3 shows an illustration of a tunable film apparatus placed in front of a screen according to an aspect of an exemplary embodiment;

FIG. 4 shows an illustration of a tunable film apparatus placed between a screen a laser projector according to an aspect of an exemplary embodiment; and

FIG. 5 shows examples of a speckled image and an ideal image without speckle.

### DETAILED DESCRIPTION

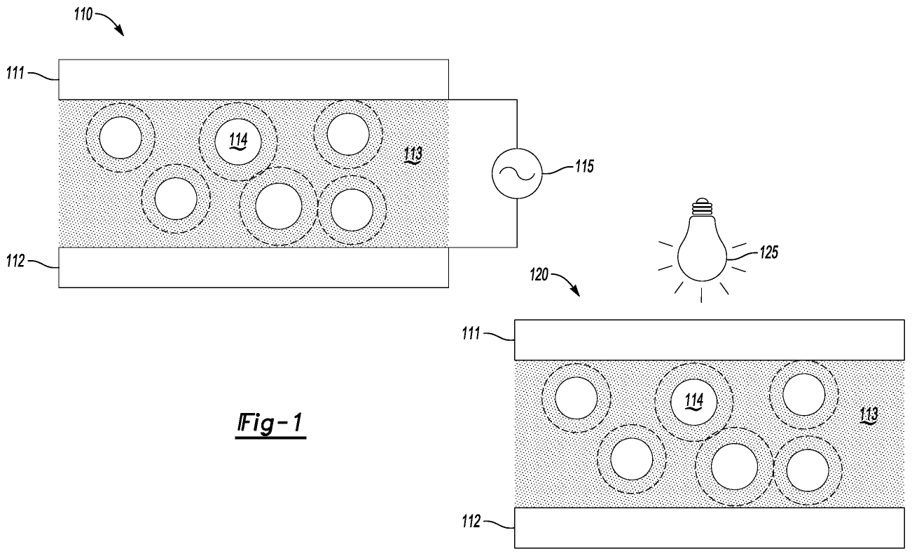

A tunable film apparatus will now be described in detail with reference to FIGS. 1-5 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “formed on,” or “disposed on” a second element, the first element may be connected directly to, formed directly on or disposed directly on the second element or there may be intervening elements between the first element and the second element, unless it is stated that a first element is “directly” connected to, formed on, or disposed on the second element. In addition, if a first element is configured to “send” or “receive” information from a second element, the first element may send or receive the information directly from the second element, send or receive the information via a bus, receive the information via a network, or send or receive the information via intermediate elements, unless the first element is indicated to receive information “directly” from the second element.

Throughout the disclosure, one or more of the elements disclosed may be combined into a single device or combined into one or more devices. In addition, individual elements may be provided on separate devices.

Laser source displays provide the benefits of having a wide color gamut and high efficiency, but projection displays using lasers as a light source suffer from image quality issues in the form of speckles appearing on the image. Speckle arises when the laser scattered by an atmospheric disturbance or rough surface and is then viewed or detected by device with a finite aperture, e.g., an observer. In a laser projection display, the presence of speckle tends to mask the image information and therefore the reduction of speckle is highly desirable

One solution to the speckled image issue is to utilize mechanical vibration or rotation for temporal averaging of the laser or light through diversification of the light angle, polarization, and wavelength. However, the mechanical vibration or rotation requires an additional motorized device, which increases the probability of mechanical failure and packaging size. The tunable film apparatus introduces a device that generates temporal averaging effect without mechanically induced temporal averaging. The tunable film apparatus may use a mechanism is configured to change, adjust or vary a light diffusing angle.

FIG. 1 shows illustrations of tunable film apparatuses according to several aspects of an exemplary embodiment.

Referring to FIG. 1 a first tunable film apparatus 110 and a second tunable film apparatus 120 are shown. However, the first tunable film apparatus is not limited to examples shown in FIG. 1 and may be configured differently.

The first tunable film apparatus 110 may include a first layer 111, a second layer 112, a liquid crystal layer 114 and elastomers 113. The liquid crystal layer 114 and elastomers 113 are disposed between the first and second layers 111 and 112. The liquid crystals 114 may be suspended in the elastomer 113 and form a matrix. The first and second layers 111 and 112 may be glass or plastic substrates. The first tunable film apparatus 110 may also include a first type of tuner 115.

The first type of tuner 115 may be a waveform generator configured to output a waveform to the tunable liquid crystal layer 114. The frequency of the waveform may be greater than a refresh rate of a display configured to display an image or receive light or laser transmitted through the tunable liquid crystal layer 114. The first type of tuner 115 may introduce temporal averaging by introducing an electrical voltage to first layer 111 and second layer 112, thereby causing the elastomers 113 to vary the size of liquid crystal domain and hence vary a light diffusing angle of the tunable film. The elastomer 113 corresponding to the first type of tuner 115 may be a side-chain azobenzene elastomer or main-chain azobenzene elastomer

The second tunable film apparatus 120 may include a first layer 111, a second layer 112, a liquid crystal layer 114 and elastomers 113. The liquid crystal layer 114 and elastomers 113 are disposed between the first and second layers 111 and 112. The liquid crystal 114 may be suspended in the elastomer 113 and form a matrix. The elastomer 113 may form a polymer matrix. The second tunable film apparatus 120 may also include a second type of tuner 125. The elastomer 113 corresponding to the second type of tuner 125 may be a silicone dielectric elastomer.

The second type of tuner 125 may be an illumination device configured to output a multi-wavelength light to the tunable liquid crystal layer. The illumination device may be a light, a diode, a laser, etc. The second type of tuner 125 may introduce temporal averaging by causing the elastomers 113 in the liquid crystal layer 114 to vary the size of liquid crystal domain and hence temporally vary light diffusing angle of the tunable film.

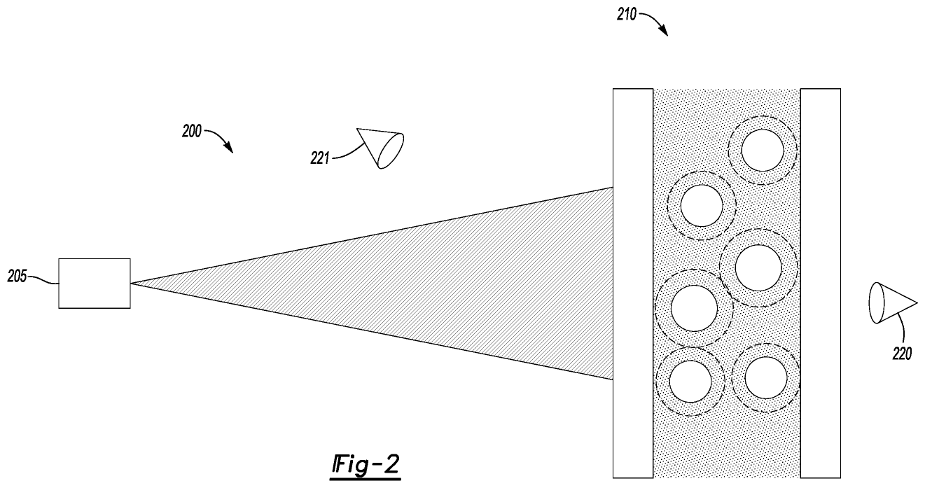

FIG. 2 shows an illustration of a tunable film apparatus used as a screen according to an aspect of an exemplary embodiment. Referring to FIG. 2, a first diagram 200 showing a tunable film apparatus 210 is embedded in or part of a display used to display images generated by laser projector 205. The tunable film apparatus 210 may be one of a first tunable film apparatus 110 or a second tunable film apparatus 120. The tunable film apparatus 210 is configured to temporally average the laser projected by generated by laser projector 205 thereby varying light diffusing angle and act as a projection screen in the illustration. The display may reflect the projection of the laser projector 205 to by viewable by viewer 221 or transmit the projection of the laser projector 205 to by viewable by viewer 220.

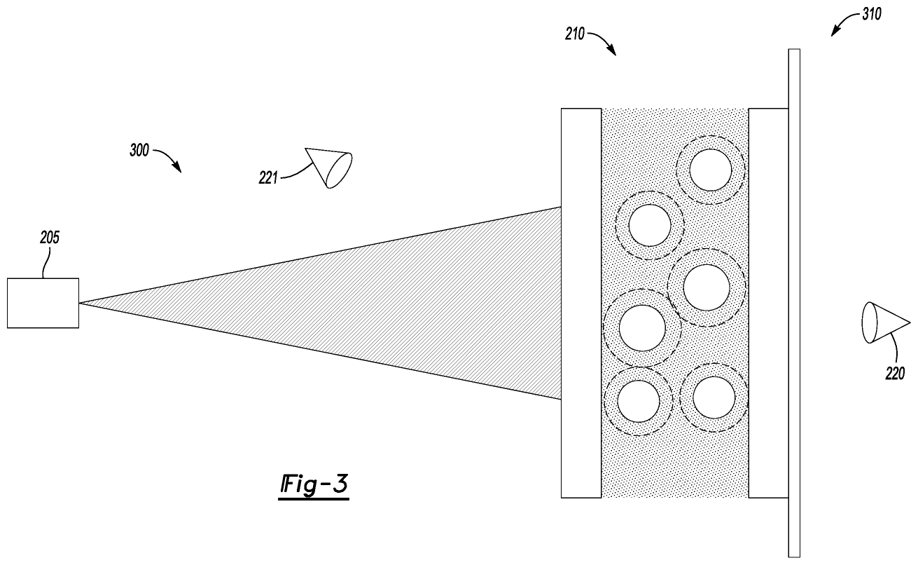

FIG. 3 shows an illustration of a tunable film apparatus placed in front of a screen according to an aspect of an exemplary embodiment.

Referring to FIG. 3, a second diagram 300 showing a tunable film apparatus 210 is disposed adjacent to a screen 310 used to display images generated by laser projector 205. The tunable film apparatus 210 is configured to temporally average the laser image projected by generated by laser projector 205 thereby varying light diffusing angle of the tunable film. The display 310 may reflect the projection of the laser projector 205 to by viewable by viewer 221 or transmit the projection of the laser projector 205 to by viewable by viewer 220.

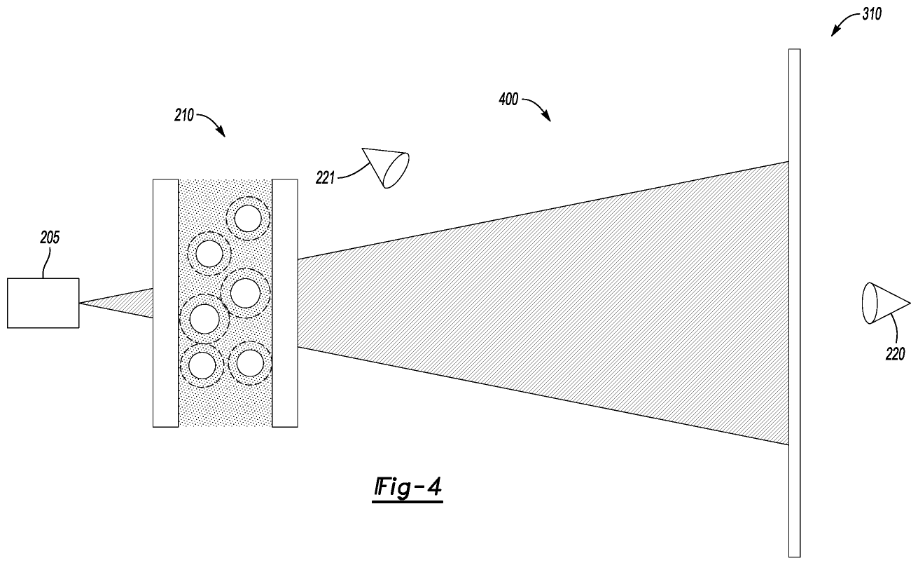

FIG. 4 shows an illustration of a tunable film apparatus placed between a screen a laser projector according to an aspect of an exemplary embodiment.

Referring to FIG. 4, a third diagram 400 showing a tunable film apparatus 210 is disposed between a display or screen 310 used to display images generated by laser projector 205 and the laser projector 205. The tunable film apparatus 210 is configured to temporally average the laser projected by generated by laser projector 205 thereby temporally varying the light diffusing angle of the liquid crystal layer. The display 310 may reflect the projection of the laser projector 205 to by viewable by viewer 221 or transmit the projection of the laser projector 205 to by viewable by viewer 220.

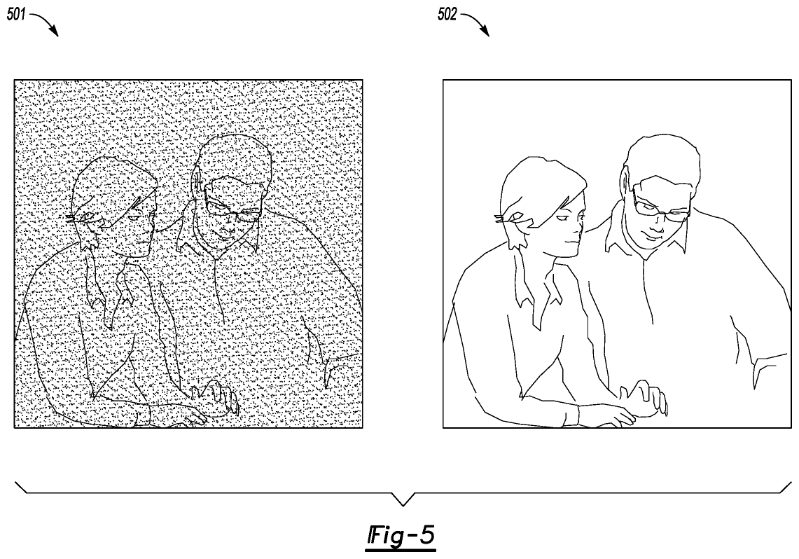

FIG. 5 shows examples of a speckled image and an ideal image without speckle.

Referring to FIG. 5, a first image 501 shows the result of speckle caused when a light or laser is scattered by an atmospheric disturbance or rough surface. As shown in 501 black dots appear on the image causing poor image quality. In contrast to image 501, image 502 shows an ideal image with clean crisp shades and no speckle or black dots.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A tunable film apparatus, the apparatus comprising:
first and second layers;
a tunable liquid crystal layer disposed between the first and second layers; and
a tuner configured to tune the tunable liquid crystal layer to adjust a light diffusing angle of the tunable liquid crystal layer.

2. The apparatus of claim 1, wherein the first and second layers comprise glass substrates or plastic substrates.

3. The apparatus of claim 1, wherein the tunable liquid crystal film comprises liquid crystals suspended in an elastomer.

4. The apparatus of claim 3, wherein the elastomers form a polymer matrix.

5. The apparatus of claim 4, wherein the elastomer comprises a side-chain azobenzene elastomer or main-chain azobenzene elastomer.

6. The apparatus of claim 4, wherein the elastomer comprises a silicone dielectric elastomer.

7. The apparatus of claim 1, wherein the tuner is configured to output a waveform to the tunable liquid crystal layer.

8. The apparatus of claim 7, wherein the frequency of the waveform is greater than a refresh rate of a display configured to receive light transmitted through the tunable liquid crystal layer.

9. The apparatus of claim 7, wherein the tuner comprises a waveform generator configured to output the waveform.

10. The apparatus of claim 1, wherein the tuner is configured to output a multi-wavelength light to the tunable liquid crystal layer.

11. The apparatus of claim 10, wherein the tuner comprises an illumination device configured to output the light.

12. The apparatus of claim 1, wherein the tuner is configured to introduce temporal averaging in the tunable liquid crystal layer.

13. The apparatus of claim 1, wherein the tunable film apparatus is a display configured to receive a laser to display an image.

14. The apparatus of claim 1, wherein the tunable film apparatus is disposed on top of a screen and a laser projector, and is configured to receive a laser from the laser projector.

15. The apparatus of claim 1, wherein the tunable film apparatus is disposed between a screen and a laser projector, and is configured to receive a laser from the laser projector and transmit the received laser to the screen.
